(19) United States
(12) Patent Application Publication
(10) Pub. No.: US 2006/0209665 A1
(43) Pub. Date: Sep. 21, 2006

(54) Multi-speed recordable information carrier

(75) Inventors: Frank Cornelis Penning, Eindhoven (NL); Bart Van Rompaey, Eindhoven (NL); Michael Van Der Aa, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/549,366

(22) PCT Filed: Mar. 8, 2004
(86) PCT No.: PCT/IB04/00751

§ 371 Date: Sep. 14, 2005

(30) Foreign Application Priority Data
Mar. 17, 2003 (EP) 032906711

(51) Int. Cl. G11B 7/26

(52) U.S. Cl. 369/288

(57) ABSTRACT

The invention relates to an information carrier comprising at least a first area (12) comprising a first recordable material having thermal properties suitable for writing at a first recording speed and a second area (13) comprising a second recordable material having thermal properties suitable for writing at a second recording speed. The second recording speed is greater than the first recording speed.

### FIELD OF THE INVENTION

The present invention relates to a recordable information carrier.

The present invention also relates to an optical scanning device for recording information on such an information carrier.

The present invention is particularly relevant for optical data storage and optical disc apparatuses for recording data on recordable discs, particularly portable devices.

### BACKGROUND OF THE INVENTION

Storing data on an information carrier by means of an optical beam is widely used. For example, portable recording apparatuses, such as laptops, are already available. When a user wants to record information on an information carrier such as an optical disc, for example information stored in the hard disc of his laptop, it is preferable that this recording take a relatively short time. Hence, it is preferable that the recording apparatus has a relatively high recording speed. However, recording information at high speed consumes a large amount of power, so that in a mobile, environment, i.e. when the recording device is battery-operated, high recording speed can often not be obtained.

Thus, it is desired that the recording device has at least two recording speeds, a relatively low recording speed used in a mobile environment and a relatively large recording speed used when sufficient power is provided to the recording device, for example when the recording device is connected up with a power chord to a main supply.

Recording devices are known, which allow writing on information carriers at different speeds. Information carriers that can be recorded at different recording speeds are also known. For example, patent U.S. Pat. No. 6,388,978, granted in May 2002, describes a rewritable information carrier, which can be written at three different recording speeds. In this patent, the largest recording speed is four times larger than the lowest recording speed. The described information carrier comprises a phase-change optical recording medium, which can be written at these recording speeds. However, such a recording medium, which can be written at recording speeds in a relatively large range, is difficult to manufacture, and complicated methods are required in order to be able to record information on such an information carrier at different recording speeds. Notably, as stated in this patent, the composition of the recording material and the recording method must be adjusted in accordance with a range of recording speeds to be used. Moreover, even if the range of available recording speeds is relatively large, this range is limited, and it is not possible to have a rewritable information carrier with a high recording speed more than four times the low recording speed.

WORM (Write Once Read Many) information carriers are also known, which can be recorded at different recorded speeds. However again, the range of recording speeds of these information carriers is limited, and the widest the range of recording speeds, the more difficult to manufacture the recording material.

### SUMMARY OF THE INVENTION

It is an object of the invention to provide a recordable information carrier, which is easy to manufacture and can be recorded at different recording speeds.

To this end, the invention proposes an information carrier comprising at least a first area comprising a first recordable material having thermal properties suitable for writing at a first recording speed and a second area comprising a second recordable material having thermal properties suitable for writing at a second recording speed, the second recording speed being greater than the first recording speed.

In the background art, a same recording material is used in the information carrier. However, in order to be written at a relatively high speed, a recording material needs to be more temperature sensitive than in order to be written at a relatively low speed. This explains why the range of recording speeds is limited when a single recording material is used.

According to the invention, at least two different recording materials are used in the information carrier. A first recording material can be chosen to be suitable for writing at a relatively low speed, whereas a second recording material can be chosen to be suitable for writing at a relatively high speed. As a consequence, such an information carrier is easy to manufacture, because a lot of materials having different thermal properties suitable for different recording speeds are known and can be used. Moreover, the range of recording speeds that can be obtained is relatively wide, because different recording materials can be used, which have highly different recording speeds.

In an advantageous embodiment, the first and second areas are on a same layer of the information carrier. This allows providing a one-layer information carrier, which can be used in conventional recorders and readers.

Advantageously, the information carrier comprises a central part, the first area being nearer to said central part than the second area. In a recordable disc, which is rotated during writing, outer regions of the disc need to be rotated at a lower speed than inner regions of the disc, in order to record at the same recording speed. Thus, recording in outer regions of the disc consumes less power. As a consequence, if the outer regions comprise the material having a high recording speed, writing in these regions is possible, even if the device is in a mobile environment.

In a preferred embodiment, the information carrier comprises at least two information layers, a first information layer comprising a first recordable material having thermal properties suitable for writing at a first recording speed and a second information layer comprising a second recordable material having thermal properties suitable for writing at a second recording speed, the second recording speed being greater than the first recording speed.

Such a multi-layer information carrier is particularly easy to manufacture. Conventional techniques can be used, such as vapour deposition and techniques commonly used in the manufacture of two-layers DVD (DVD stands for Digital Versatile Disc).

The invention also relates to an optical scanning device for recording information on an information carrier as described above, said information carrier comprising a location area on which information on a location of the first and of the second area is recorded, said optical scanning device comprising a first recording mode and a second recording mode, said device comprising means for selecting a recording mode, means for reading information recorded on said location area and means for determining a writing location on the basis of said information and said selected recording mode.

The invention also relates to a portable device comprising such an optical scanning device. Advantageously, the selecting means are adapted for selecting a recording mode on the basis of a power mode of said portable device. The power mode can be detected by means of a measure of the power supplied to the portable device. The portable device can also detect the power mode by detecting, for example, if a power chord is attached to the portable device or not.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an information carrier in accordance with an advantageous embodiment of the invention;

FIG. 2 shows an information carrier in accordance with a preferred embodiment of the invention;

FIG. 3 shows a portable device in accordance with the invention;

FIG. 4 shows an optical scanning device in accordance with the invention.

### DETAILED DESCRIPTION OF THE INVENTION

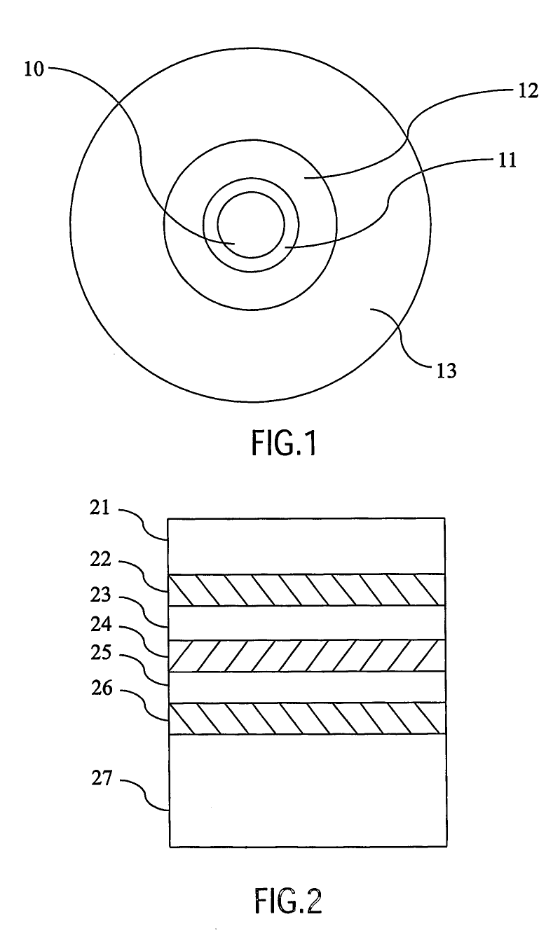

An information carrier in accordance with an advantageous embodiment of the invention is depicted in FIG. 1. Such an information carrier comprises a central hole 10, a location area 11, a first area 12 and a second area 13. The first area 12 comprises a first recordable material, which is suitable for writing at a first speed and the second area 13 comprises a second recordable material, which is suitable for writing at a second speed. The second speed is greater than the first speed.

The first and second materials can be WORM (Write Once Read Many) materials. In this case, writing in the first and second areas 12 and 13 consists in degrading the WORM materials, by means of an optical beam. Pits and lands are formed at the surface of the first and second areas 12 and 13, which pits and lands comprise the information written on the information carrier.

The first and second material can also be RW (ReWritable) materials. Example of RW material is a phase-change optical recording material. Writing on a phase-change optical recording material by means of an optical beam is based on a transformation between a crystal and a non-crystal phase or between two different crystal phases. Information can thus be written on the recording material, and then easily erased by means of the optical beam.

Alternatively, one among the first and second recording materials can be a WORM material, and the other a RW material. As a consequence, the word “recordable” means WORM or RW.

It is important to notice that an information carrier in accordance with the invention can comprise more than two areas having different recording materials suitable for writing at different recording speeds. For example, the information carrier of FIG. 1 can comprise a third area with a third recording material having thermal properties suitable for writing at a third recording speed.

In the example described hereinafter, the information carrier of FIG. 1 comprises a first RW material in the first area 12 and a second RW material in the second area 13. The first and second materials have different recording speeds. The recording speed is usually defined as the linear recording velocity. In CD-RW (Compact Disc-ReWritable), a single recording speed has been defined, which is between 1.2 and 1.4 m/s. From this single recording speed, other recording speeds can be defined, such as a 2× recording speed, which is between 2.4 and 2.8 m/s, a 3× recording speed between 3.6 and 4.2 m/s and so on. The example described hereinafter applies to an information carrier with a first area 12 comprising a RW material with a 1× recording speed and a second area 13 comprising a RW material with a 6× recording speed. In this information carrier, the density of information is the same in the first and second area 12 and 13. In order to write information, the RW material is locally heated my means of an optical beam, in order to induce a phase-change. As the recording speed is higher when a writing is performed in the second area 13, the second recording material has to be more temperature-sensitive than the first recording material, so that the phase-change occurs more rapidly in the second material than in the first material.

As a consequence, the second RW material is chosen so as to have thermal properties suitable for writing at a 6× recording speed and the first recording material is chosen so as to have thermal properties suitable for writing at a 1× recording speed.

Materials having different recording speeds can be expressed as GewInxSbyTez, where w and x are between 0 and 5 percent, y is between 70 and 90 percent and z is between 5 and 30 percent, and the sum of w, x, y and z is 100 percent. By varying the composition, i.e. by varying w, x, y and z, it is possible to obtain different materials having different thermal properties. Such a material is known for use in CD-RW and can have a recording speed between 1× and 10×, depending on the values of w, x, y and z.

The information carrier of FIG. 1, which comprises an information layer having different recording materials in the first and second areas 12 and 13, can easily be manufactured. For example, a mask can be created, which mask as the shape of the information carrier of FIG. 1, and a hole having the shape of the first area 12. This mask is placed above the information carrier, and the first recordable material is deposited through the mask on the information carrier, using sputter deposition for example. The mask can be a diaphragm with a hole having the shape of a part of the first area, for example a fourth or half the first area 12. During deposition of the recording material, the mask or the information carrier is rotated. This lead to a more homogenous deposition of the first recording material. The mask and the information carrier can be rotated in opposite directions during deposition of the first material. Then, another mask is used in order to deposit the second recording material on the second area 13.

The power needed for writing at a 6× recording speed is higher than the power needed for writing at a 1× recording speed. Actually, in order to write at a 6× recording speed, the information carrier has to be rotated at a higher speed than in order to write at a 1× recording speed. Moreover, the optical beam has to be pulsed at a higher frequency than for writing at a 1× recording speed.

As a consequence, the invention is particularly advantageous for use in a battery-operated portable device. Such a battery-operated portable device can be in a mobile environment, where power is supplied by the battery. In this case, the available power is relatively low. The portable device can also be in a fixed environment, for example when it is placed in a cradle connected up with a power chord. In this case, the available power is larger. When a user wants to write information on the information carrier in accordance with the invention, with a portable device in a mobile environment, information can be written in the first area 12, because such a writing requires a relatively low power, which can be provided by the battery. When the user wants to write information with a portable device in a fixed environment, information can be written in the second area 13, because the power required for such a writing at high recording speed can be provided by the power chord. As a consequence, only one information carrier is needed in order to write at different recording speeds.

In the example of FIG. 1, the first area 12 is located near the central hole 10, and the second area 13 is located in the outer regions of the information carrier. Of course, these locations can be inverted. Having the first area 12 in the inner regions of the information carrier and the second area 13 in the outer regions of the information carrier is particularly advantageous. Actually, for a same recording speed, i.e. a same linear recording velocity, writing in outer regions of a disc requires a lower speed of rotation of the disc than for writing in inner regions of a disc. As a consequence, if a user wants to write information in the second area 13 while his portable device is in a mobile environment, the amount of power needed is less than with the second area 13 located in the inner regions of the disc.

But having the first area 12 in the outer regions of the information carrier and the second area 13 in the inner regions of the information carrier is also advantageous. Actually, if a user wants to write information in the first area 12 while his portable device is in a mobile environment, the amount of power needed is less than with the first area 12 located in the inner regions of the disc. As a consequence, writing on the information carrier is possible, even if a low power is available in the portable device. In this case, writing information in the second area 13, while the portable device is in a fixed environment, requires more power than with the second area 13 in the outer regions of the disc, but this is not a problem, as the available power is relatively large in a fixed environment.

The information carrier of FIG. 1 comprises a location area 11, which comprises information on a location of the first and of the second area 12 and 13. This location area is particularly useful for an optical scanning device using this information carrier, in order to know where information has to be written, depending on the recording speed. The location area might also comprise information on the recording speed of each area, or this information can be written in a separate speed area. The information on the recording speed can be the recording speed itself, or other information such as a writing strategy.

For example, information on a location and a recording speed of the first and of the second area 12 and 13 might be recorded in the lead-in area of the information carrier. During manufacture of the information carrier, a stamper is used in order to print pre-grooves on the recording materials, which pre-grooves are used during writing for tracking. The stamper can be used for recording information in the lead-in area. Alternatively, information in the lead-in area can be written during manufacture by means of an optical beam if the lead-in area comprises a recordable material.

FIG. 2 shows an information carrier in accordance with a preferred embodiment of the invention. This information carrier comprises a cover layer 21, a first information layer 22, a first spacer layer 23, a second information layer 24, a second spacer layer 25, a third information layer 26 and a substrate 27. The first information layer 22 comprises a first recordable material having thermal properties suitable for writing at a first recording speed, the second information layer 24 comprises a second recordable material having thermal properties suitable for writing at a second recording speed and the third information layer 26 comprises a third recordable material having thermal properties suitable for writing at a third recording speed. For example, the first recording material is a 1× RW material, the second recordable material is a 3× RW material and the third recordable material is a 6× RW material.

Such an information carrier is particularly easy to manufacture. Actually, conventional techniques, like the techniques commonly used in the manufacture of DVDs, can be used. For example, the third recordable material is deposited on the substrate 27, by means of vapour deposition. The third information layer 26 is obtained. Then, the second spacer layer 25 is deposited on the third information layer 26. Then, the second recordable material is deposited on the second spacer layer 25. The second information layer 24 is obtained. Then, the first spacer layer 23 is deposited on the second information layer 24. Then, the first recordable material is deposited on the first spacer layer 23. The first information layer 22 is obtained. Then, the cover layer 21 is deposited on the first information layer 22.

Such an information carrier is scanned by an optical beam through the cover layer 21. Preferably, the information layer having the lowest recording speed is close to the cover layer 21, as depicted in FIG. 2. Actually, writing with the optical beam on the second and third information layers 24 and 26 requires more power than writing on the first information layer 22, because a part of the optical beam is absorbed in the first information layer 22. As the first information layer 22 is intended to be used in a mobile environment, where the available power is low, it is preferable that writing on the first information layer 22 is not perturbed by the second and third information layers 24 and 26.

Furthermore, it is preferable that the first information layer 22 has a lower absorption than the second and third information layers 24 and 26, in order to have enough write power for writing on these information layers 24 and 26. This is the case in the information carrier of FIG. 2, because the first information layer 22 comprises a recording material with a low recording speed, which is less temperature-sensitive and thus has a lower absorption than a recording material with a higher recording speed.

For the same reasons, it is preferable that the second information layer 24 has a lower absorption than the third information layer 26 and is located closer to the cover layer 21 than the third information layer 26.

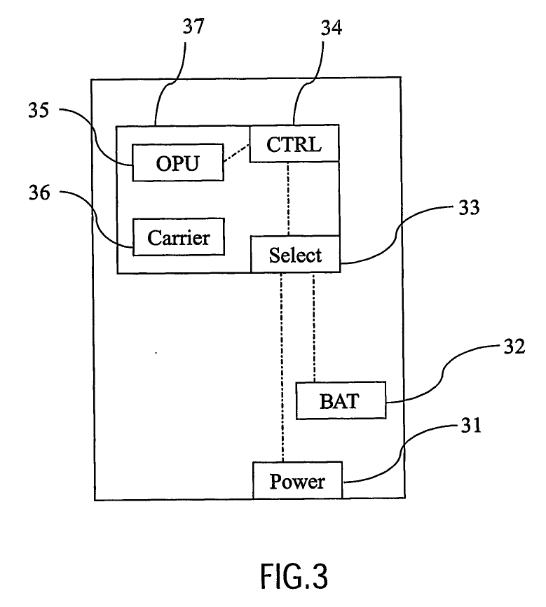

FIG. 3 shows a portable device in accordance with the invention. This portable device comprises a power interface 31, a battery 32, selecting means 33, control means 34 and an optical pick-up unit 35. The selecting means 33, the control means 34 and the optical pick-up unit 35 are parts of an optical scanning device 37. The optical scanning device 37 is adapted to receive an information carrier 36.

Examples of such a portable device are a mobile phone or a cordless phone, a palmtop computer, a laptop, a digital camera or a camcorder. Power can be supplied to the portable device by means of an AC/DC power adaptor connected to a main supply, which adaptor is connected to the power interface 31. In a mobile environment, power is supplied by the battery 32, which can also be accumulators.

The optical scanning device 37 is for example a small form factor optical drive. The optical scanning device has at least a first and a second recording mode. When a user wants to write information on the information carrier 36, the selecting means 33 select a recording mode. This can be performed according to the environment. If the selecting means detects that power is supplied at the power interface 31, i.e. the portable device is in a fixed environment, a high speed recording mode is selected. If the selecting means 33 detects that no power is supplied at the power interface 31, i.e. the portable device is in a mobile environment, a low speed recording mode is selected. The recording mode can also be selected on the basis of a measure of the available power, which can be performed by the selecting means 33. For example, in a mobile environment, the selected recording mode can depend on a level of power of the battery 32. The recording mode can also be chosen by a user, by means of an interface of the portable device.

Then, the portable device has to know the recording speed corresponding to the selected recording mode. It is possible that the portable device as well as the information carrier 36 are standard, so that the control means 34 knows the available recording speeds in the information carrier 36, without reading said information carrier 36. It is preferable that the information carrier 36 comprises a speed area where information on the recording speed of the first and of the second area is recorded. In this case, the control means 34 ask the optical pick-up unit 35 to read said speed area in order to detect the available recording speeds. Then, depending on the available recording speeds and the selected recording mode, the control means 34 decide at which recording speed information has to be written. For example, if the information carrier 36 is the information carrier of FIG. 1, with a 1× and a 6× RW material, and a high speed recording mode has been selected, information are written at a 6× recording speed.

Once the recording speed has been selected, information is written on the information carrier 36. The control means 34 first have to know where information has to be written. If the portable device as well as the information carrier 36 are standard, the control means 34 can know the location of the areas of the information carrier 36, without reading said information carrier 36. It is preferable that the information carrier 36 comprises a location area where information on a location of the first and of the second area is recorded. In this case, the control means 34 ask the optical pick-up unit 35 to read said location area in order to detect the locations of the different areas of the information carrier 36, or only the location of the area corresponding to the selected recording speed. Then, the control means 34 determine a writing location, which depends on the selected recording mode and the information recorded in the location area. Information on a location of an area can be, for example, a number of tracks at which said area begins, starting from a first track of the information carrier.

Then, the control means 34 set parameters of the optical pick-up unit 35, such as the pulsing frequency of the optical beam. The speed of rotation of the information carrier 36 is also set in accordance with the recording speed, and a writing of information is performed.

The example described hereinbefore applies to a portable device having two recording modes. Of course, the invention applies to a portable device having more than two recording modes. For example, a portable device having three recording modes can be used with the information carrier of FIG. 2. For example, a low speed recording mode, a medium speed recording mode and a high speed recording mode can be defined, based on the level of power of the battery 32.

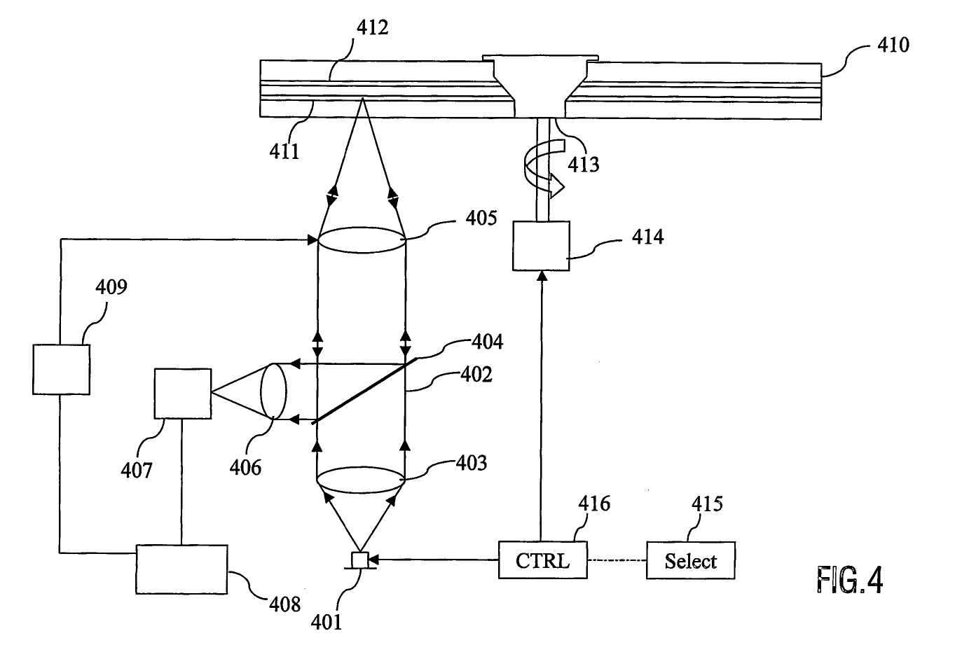

FIG. 4 shows an optical scanning device in accordance with the invention. Such an optical device comprises a radiation source 401 for producing an optical beam 402, a collimator lens 403, a beam splitter 404, an objective lens 405, a servo lens 406, detecting means 407, measuring means 408 and a controller 409. This optical device is intended for scanning an information carrier 410. In this example, the information carrier 410 comprises two information layers 411 and 412, said information layers 411 and 412 comprising two recording materials having different recording speeds.

During a scanning operation, which can be a writing operation or a reading operation, the information carrier 410 is scanned by the optical beam 402 produced by the radiation source 401. The collimator lens 403 and the objective lens 405 focus the optical beam 402 on an information layer of the information carrier 410. The collimator lens 403 and the objective lens 405 are focussing means. During a scanning operation, a focus error signal might be detected, corresponding to an error of positioning of the optical beam 402 on the information layer. This focus error signal might be used in order to correct the axial position of the objective lens 405, in order to compensate for a focus error of the optical beam 402. A signal is sent to the controller 409, which drives an actuator in order to move the objective lens 405 axially.

The focus error signal and the data written on the information layer are detected by the detecting means 407. The optical beam 402, reflected by the information carrier 410, is transformed to a parallel beam by the objective lens 405, and then reaches the servo lens 406, thanks to the beam splitter 404. This reflected beam then reaches the detecting means 407.

The radiation source 401, the collimator lens 403, the beam splitter 404, the objective lens 405, the servo lens 406, the detecting means 407, the measuring means 408 and the controller 409 form an optical pick-up unit. This optical pick-up unit can be translated so that the whole information carrier 410 can be scanned.

The optical device further comprises a clamper 413 for receiving the information carrier 410. The information carrier 410 is fixed to the clamper 413, which can be rotated by means of a rotor 414. The optical scanning device further comprises selecting means 415 for selecting a recording mode. It should be noticed that these selecting means 415 can also simply receive a recording mode from a portable device, which recording mode has been defined by the portable device. The scanning device further comprises control means 416, which control the optical pick-up unit as well as the rotor 414, according to the recording mode. The control means 416 can be responsible for defining the recording speed, as described in FIG. 3. The control means set the speed of rotation of the rotor 414 so that it is adapted to the recording speed. The control means 416 also set the pulsing frequency of the optical source 401, so that it is adapted to the recording speed. The control means also controls other parameters of the optical pick-up unit, such as a radial position of the optical pick-up unit.

It should be noticed that in another embodiment, the signal corresponding to information written in the information carrier 410 can be detected in transmission by a second objective lens, a second servo lens and second detecting means, which are placed opposed to the objective lens 405, the servo lens 406 and the detecting means 407, compared to the information carrier 410.

It should also be noticed that in another embodiment, the information carrier 410 can have a mirror at the back of the whole carrier, that reflects the beam transmitted through all information layers, including the addressed one. In this case, the optical scanning device as shown in FIG. 4 can be used to read the data.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An information carrier comprising at least a first area (12) comprising a first recordable material having thermal properties suitable for writing at a first recording speed and a second area (13) comprising a second recordable material having thermal properties suitable for writing at a second recording speed, the second recording speed being greater than the first recording speed.

2. An information carrier as claimed in claim 1, wherein the first and second areas are on a same layer of the information carrier.

3. An information carrier as claimed in claim 2, said information carrier comprising a central part (10), the first area being nearer to said central part than the second area.

4. An information carrier as claimed in claim 1, said information carrier comprising at least two information layers (22, 24), a first information layer comprising a first recordable material having thermal properties suitable for writing at a first recording speed and a second information layer comprising a second recordable material having thermal properties suitable for writing at a second recording speed, the second recording speed being greater than the first recording speed.

5. An information carrier as claimed in claim 1, said information carrier comprising a location area (11) on which information on a location of the first and of the second area is recorded.

6. An information carrier as claimed in claim 5, said information carrier comprising a speed area on which information on a recording speed of the first and of the second area is recorded.

7. An optical scanning device for recording information on an information carrier (410) as claimed in claim 5, said optical scanning device comprising a first recording mode and a second recording mode, said device comprising means for selecting a recording mode (415), means for reading (35) information recorded on said location area and means for determining a writing location on the basis of said information and said selected recording mode.

8. A portable device comprising an optical scanning device as claimed in claim 7, wherein said selecting means are adapted for selecting a recording mode on the basis of a power mode of said portable device.
